(19) United States
(12) Patent Application Publication
(10) Pub. No.: US 2008/0297650 A1
(43) Pub. Date: Dec. 4, 2008

(54) IMAGE PHOTOGRAPHING DEVICE

(75) Inventor: Won-Min SON, Kyeonggi-do (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: Hysonic Co., Ltd., Kyeonggi-do (KR)

(21) Appl. No.: 12/182,217

(22) Filed: Jul. 30, 2008

(30) Foreign Application Priority Data
May 10, 2007 (KR) 10-2007-0045277
Apr. 1, 2008 (KR) PCT/KR2008/001823

(51) Int. Cl. H04N 5/225

(52) U.S. Cl. 348/372; 348/E05.024

(57) ABSTRACT

Disclosed is an image photographing device. Particularly, this invention intends to provide the image photographing device having a lower board spring that is easily manufactured and assembled by forming a terminal part on a supporting portion. In order to accomplish the above objects, the present invention comprises a lower board spring for supporting a lens holder by connecting with a fixed part, wherein the lens holder has a lens and is driven in the direction of an optical axis; a supporting part disposed on the lower portion of the lower board spring; and a terminal part for supplying electric power, wherein the terminal part is formed on the supporting part, and the shape of the lower board spring is a flat board-shape, and the terminal part is contacted to the lower board spring.

### CROSS-REFERENCE TO PRIORITY APPLICATION

This application hereby claims the benefit of the commonly assigned Korean application No. 10-2007-0045277 (filed May 10, 2007, in the Korean Patent Office) and the commonly assigned International Patent Application No. PCT/KR2008/001823 (filed Apr. 1, 2008, in the Korean Patent Office), both of which are hereby incorporated by reference in their entirety.

### FIELD OF THE INVENTION

The present invention relates to an image photographing device for a camera, and more particularly, to an image photographing device that promotes ease of manufacturing and assembling a board spring by providing a separate terminal part on a supporting portion of the device.

### BACKGROUND

An image photographing device is mounted on small communication devices such as portable phones. FIG. 1 is a transversal cross-section view according to a conventional image photographing device. The image photographing device shown in FIG. 1 comprises a lens group 500 composed of a plurality of lens for controlling the magnification of a subject, a lens holder 550 for mounting the lens group 500 and driving the lens group 500 in the direction of an optical axis, a fixing part 600, and board springs that cause the lens holder 550 to move in the direction of the optical axis, wherein the board springs are supported by the fixing part 600. The board springs guide and drive the lens holder 550 in the direction of the optical axis. The device further comprises an actuator for driving the fixing part 600 in the direction of the optical axis, wherein the actuator is supported by the lens holder 550. The device also comprises an image sensor 800 for photographing a subject image projected through the lens group 500, a controller for controlling the actuator and the image sensor 800, and a supporting part 900 disposed on the lower area of the fixing part 600 and the lens holder 550.

The board springs 650,660 include an upper board spring 650 disposed on the top of the lens holder 550 and a lower board spring 660 disposed on the bottom of the lens holder 550. As shown in FIG. 2, the board springs 650,660 have a transformable or flexible part which connects between the fixing part 600 and the lens holder 550, and is easily transformed of flexed during movement of the lens holder 550 in the direction of the optical axis due to a narrow width and a long length. Therefore, the board springs 650,660 flexibly support the lens holder 550 and permit the lens holder 550 to freely move in the direction of the optical axis. Moreover, the board springs 650,660 are secured to the lens holder 550 at more than four locations and guide the lens holder 550 to prevent the lens holder 550 from freely moving in the direction perpendicular to the optical axis.

The actuator comprises a magnet 710 fixed on the fixing part 600, and a coil 720 fixed on the lens holder 550. The actuator receives a magnetic flux from the magnet 710 when power is supplied from the controller and generates a force for driving the lens holder 550 in the direction of the optical axis. The magnet 710 and the coil 720 are symmetrically disposed as a pair respectively. The actuator further includes a yoke 730 for efficiently circulating the magnetic flux of the magnet 710.

In the embodiment of the image photographing device described above, an electromagnetic force is generated to move the coil 720 in the direction of the optical axis as a result of the influence of the magnetic flux from the magnet 710 when current is supplied from the controller to the coil 720 of the actuator. Therefore, movement of the coil 720 causes movement of the lens holder because the coil is fixed to the lens holder. Accordingly the coil 720 and lens holder 550 move in the direction of the optical axis.

Based on the above mentioned structure, the controller sharpens images appearing in the image sensor 800 by raising or descending the lens group 500 in the direction of the optical axis. In other words, the controller focuses the image to be photographed.

The lower board spring 660 is connected to the coil 720. Current is supplied to the coil 720 through the lower board spring 660. As configured, the lower board spring 660 guides the lens holder 550, and functions as a current terminal.

A lower portion of the lens holder 550 rests against the supporting part 900. The fixed part 600, the board springs 650, 660, and the image sensor 800 are positioned on and within interior portions of the supporting part 900.

FIG. 2 is an exploded perspective view of the supporting part 900 and the board springs 650, 660 in FIG. 1. FIG. 3 is a perspective view illustrating the lower board spring 660 of FIG. 2 connected to (i.e., positioned on) the supporting part 900.

As shown in FIGS. 2 and 3, the known lower spring board 660 includes an integral terminal part 665. The terminal part 665 protrudes from a lateral face of the lower board spring 660. The known lower board spring 660 is configured in this manner because the conventional lower board spring 660 operates as a terminal for supplying current to the coil 720 unlike the upper board spring 650.

The lower board spring 660 having the terminal part 665 is manufactured with a planar shape, and then the terminal part 665 is bent during assembly to connect the lower board spring 660 to the supporting part 900 as shown in FIG. 3.

Unfortunately, the process of bending the terminal part 665 to connect the terminal part with the lower board spring 660 during assembly of known devices requires a skilled worker. The time required to complete the bending process reduces productivity. Furthermore, the terminal part 665 may break during the bending process. Moreover, known devices restrict the location of the terminal part 665 and make it difficult to vary or change the location of the terminal part 665 if desired.

### SUMMARY OF THE INVENTION

Accordingly, the present invention provides solutions to the above referenced problems of the prior art. The present invention provides an image photographing device having a board spring that is easily manufactured and assembled. The present invention further provides an image photographing device having a terminal part separate and apart from (i.e., not integral with) a lower board spring such that one may easily change the location of the terminal part.

In order to accomplish the above objects, the present invention comprises a lower board spring for supporting a lens holder having a lens, wherein a portion of the lower board spring is connected to a lens holder and another portion is connected to a fixed part, and wherein the lens holder is driven in the direction of an optical axis; a supporting part disposed on a lower portion of the lower board spring; and a terminal part for supplying electric power, wherein the terminal part is formed on the supporting part. The shape of the lower board spring is a flat board-shape (i.e., planar), and the terminal part is connected to, and in contact with, the lower board spring.

The terminal part is made of metal, and secured to or inserted into the supporting part by way of, for example, injection. The terminal part protrudes from an upper face of the supporting part. The terminal part is contacted to (i.e., connected with) the lower board spring and the upper face of the supporting part.

The invention further provides a protrusion that extends from (i.e., extendedly formed on) both lateral sides of the terminal part, and the lower board spring is soldered to the protrusion.

A through hole is provided on the supporting part, and the terminal part is inserted into the through hole. A hook-shaped hanging part is provided on the terminal part. A projection is formed on an upper surface of the supporting part substantially adjacent to terminal part. The projection fixes the hanging part to the supporting part and prevents the terminal part from separating from the supporting part by way of the through hole.

As described above, according to the present invention, the following effects can be obtained.

First, the terminal part is manufactured as a separate part (i.e., not integral with the lower board spring). Accordingly, the terminal part may be inserted into or connected to the lower board spring or may be separately assembled on the supporting part. As a result, it is easy to manufacture the lower board spring and the workability of the device and the productivity of manufacture are increased because of the elimination of the bending process required of known devices.

Furthermore, it is possible to change the location of the terminal part according to each product regardless of the form or shape of the lower board spring. It is possible to change the location of the terminal part by inserting (or injecting) the terminal part into the supporting part, while adjusting the position of the terminal part as the lower board spring and the terminal part are separated from each other.

Second, the terminal part can be easily mounted on the supporting part and prevented from arbitrarily separating from the supporting part by forming the terminal part on the supporting part by inserting and injecting.

Third, both faces of the lower board spring and the terminal part are easily contacted and accessible because the terminal part protrudes from the top of the supporting part.

Fourth, a protrusion is extendedly formed on both lateral faces of the terminal part, and the lower board spring is soldered to the protrusion, such that the lower board spring and the terminal part are easily coupled.

The foregoing and other objects and advantages of the invention and the manner in which the same are accomplished will become clearer based on the following detailed description taken in conjunction with the accompanying drawings.

### BRIEF DESCRIPTION OF THE DRAWINGS

FIG. 1 is a transverse cross-sectional view according to a conventional image photographing device.

FIG. 2 is an exploded perspective view of a conventional supporting part and board springs of FIG. 1.

FIG. 3 is a perspective view showing the board spring and supporting part of FIG. 2 connected to one another.

FIG. 4 is an exploded perspective view of the supporting part and the lower board spring according to one embodiment of the present invention.

FIG. 5 is a perspective view showing the lower board spring and supporting part of FIG. 4 connected to one another.

FIG. 6 is a perspective view of a back side of the supporting part of FIG. 5.

FIG. 7 is a cross-sectional view of the image photographing device according to the present invention.

### DETAILED DESCRIPTION

The preferred embodiments of the present invention will be hereafter described in detail with reference to the accompanying drawings.

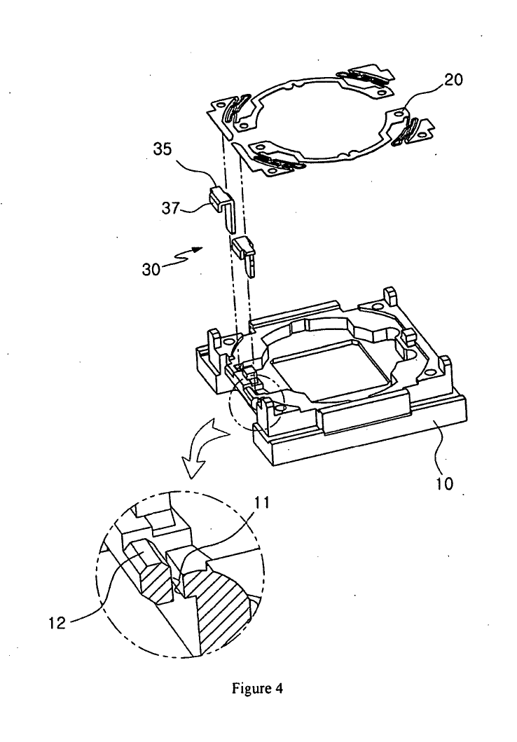

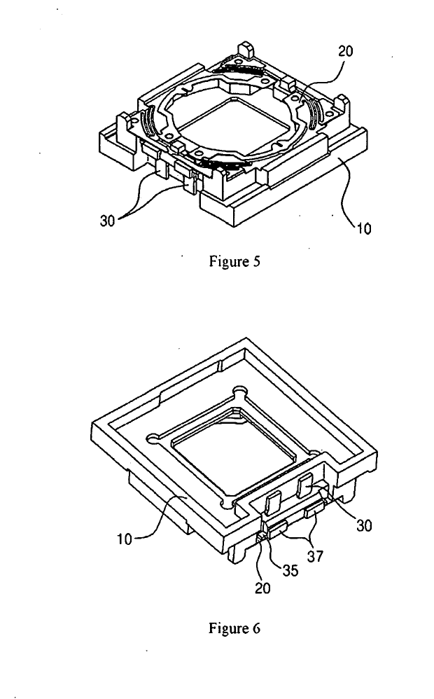

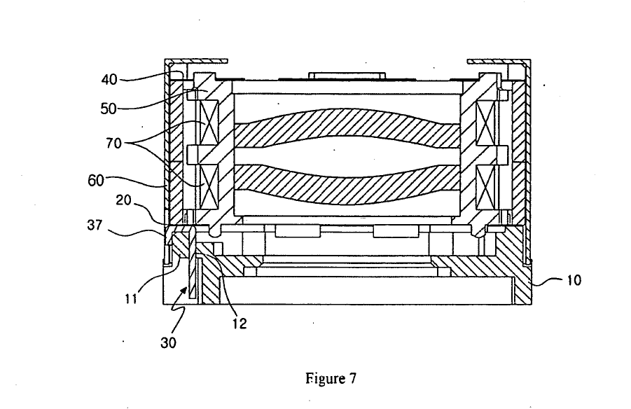

FIG. 4 is an exploded perspective view of the supporting part and the lower board spring according to the embodiment of the present invention. FIG. 5 is a perspective view showing the lower board spring and supporting part of FIG. 4 connected to one another. FIG. 6 is a perspective view of the back side of the supporting part of FIG. 5. FIG. 7 is a cross-sectional view of the image photographing device according to the present invention.

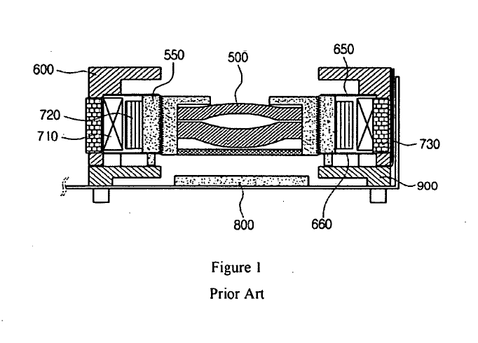

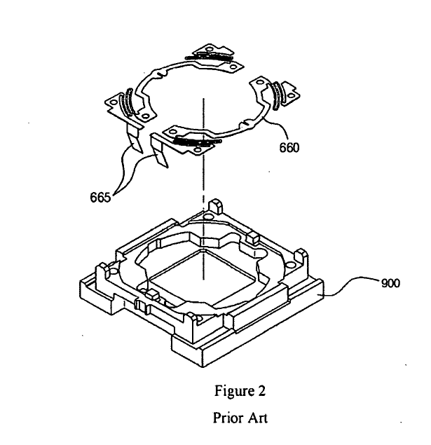

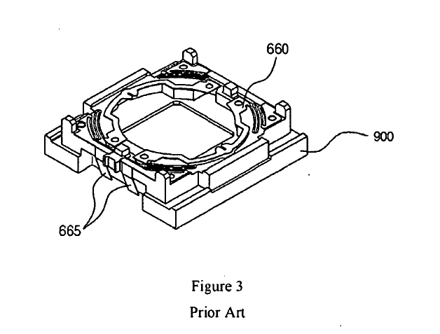

As shown in FIGS. 4 and 5, the image photographing device according to the present invention includes a different supporting part 10, lower board spring 20, and terminal part 30 as compared to the conventional image photographing device shown in FIG. 1. Accordingly, so the supporting part 10, the lower board spring 20 and the terminal part 30 of the present invention will be mainly described.

As shown in FIG. 7, the image photographing device comprise a lens holder 50 to which a lens is mounted for movement in the direction of an optical axis, a fixed part 60 into which the lens holder 50 is mounted, an upper board spring 40 and a lower board spring 20 for supporting the lens holder 50 wherein the lens holder is connected to a fixed part 60 by the lower board spring 20 such that the lower board spring 20 guides and drives the lens holder 50 in the direction of the optical axis, and a supporting part 10 disposed on the lower area of the lens holder 50 and the fixed part 60.

The supporting part 10 is disposed not only on the lower part of the lens holder 50 and the fixed part 60, but also on the bottom (or underside) of the lower board spring 20. In other words, the supporting part 10 receives the lower board spring 20, the lens holder 50, and the fixed part 60 (see FIG. 7).

A terminal part 30 to which power is supplied is mounted on the supporting part 10, wherein the terminal part 30 is made of metal, and mounted on the supporting part 10 by inserting and injecting or separately assembling. The lower board spring 20 is contacted to (i.e., connected with) the top of the terminal part 30, and a coil 70 is connected to the lower board spring 20. Therefore, current supplied through the terminal part 30 is carried to the coil 70 through the lower board spring 20.

It is easier to manufacture the lower board spring 30 having a planar shape without bending as required of known devices.

The terminal part 30 protrudes from the upper face of the supporting part 10 and contacts the face of the lower board spring 20. The lower board spring 20 contacts the upper face of the protruded supporting part 10.

A protrusion 35 is extendedly formed on both lateral faces of the terminal part 30 so that a contact part between the lower board spring 20 and the protrusion 35 is soldered while contacting the lower board spring 20 and the terminal part 30.

As mentioned above, the terminal part 30 is manufactured as a separate part from (i.e., not integral with) the lower board spring 20 and is formed separately so as to be inserted by injecting or to be separately assembled on the supporting part 10. As a result, it is easy to manufacture the lower board spring 20, and the workability of the device and the productivity of manufacturing can increase, as another bending process is not necessary.

Furthermore, it is possible to change the location of the terminal part 30 according to each product regardless of the form of the lower board spring 20 by inserting and injecting the terminal part 30 on the supporting part 10, while adjusting the position of the terminal part 30 as the lower board spring and the terminal part are separated from each other.

A through hole 11 is provided on the supporting part, and the terminal part 30 is inserted into the through hole 11 so as to separately assemble the terminal part 30 on the supporting part 10. At this time, the terminal part 30 is coupled with the supporting part 10 by using, for example, adhesives or any other material for securing parts.

Additionally, a hanging part 37 that bends downward at one end is formed on the terminal part 30. The hanging part 37 prevents the terminal part 30 from separating from the through hole 11 of the supporting part 10.

Moreover, a projection 12 for hanging and fixing the hanging part 37 is formed on the supporting part 10. Therefore, the bent hanging part 37 on the projection prevents the terminal part 30, which is inserted through the through hole 11, is from separating from the through hole 11, and thus the supporting part 10.

Although the present invention has been described with reference to several exemplary embodiments, the description is illustrative of the invention and is not to be construed as limiting the invention. Various modifications and variations may occur to those skilled in the art, without departing from the spirit and scope of the invention, as defined by the appended claims.

As described above, the image photographing device having a board spring that is easily manufactured and assembled because the lower board spring is a separate part, and not integral with, terminal part.

This feature enhances the workability of the device and increases manufacturing productivity because the location of the terminal part is easily changed.

1. An image photographing device, comprising:
a lower board spring for supporting a lens holder, the lens holder connected to a fixed part by the lower board spring, wherein the lens holder has a lens and is driven in a direction of an optical axis;
a supporting part disposed on a lower portion of the lower board spring; and
a terminal part for supplying electric power, wherein the terminal part is formed on the supporting part, and the shape of the lower board spring is a flat board-shape, and the terminal part is contacted to the lower board spring.

2. The image photographing device according to claim 1, wherein the terminal part is made of metal, and is inserted into the supporting part by injecting on the supporting part.

3. The image photographing device according to claim 1, wherein the terminal part protrudes from an upper face of the supporting part, and the lower board spring is contacted to a face of the terminal part at an upper face of the supporting part.

4. The image photographing device according to claim 1, wherein a protrusion is extendedly formed on both lateral sides of the terminal part, and the lower board spring is soldered to the protrusion.

5. The image photographing device according to any one of claims 1, wherein a through hole is formed on the supporting part, and the terminal part is inserted into the through hole.

6. The image photographing device according to claim 5, wherein a bent hanging part is formed on the terminal part, and a projection is formed to prevent the terminal part from separating from the through hole by fixing the hanging part on the supporting part.

7. An image photographing device comprising:
a supporting part;
a flexible board spring positioned on and connected to at least a portion of the supporting part;
a moveable lens holder having at least one lens, the lens holder positioned against the board spring such that one portion of the board spring is connected to the lens holder and another portion of the board spring is connected to the supporting part, the board spring guiding the lens holder during movement;
a fixed part secured to the supporting part and enclosing at least a portion of the lens holder; and
a terminal part secured to the supporting part and positioned substantially adjacent to and in contact with the board spring, the terminal part directing power from a source along the board spring to the moveable lens holder and facilitating movement of the lens holder in a direction of an optical axis;
wherein the terminal part is a separate piece connected to the supporting part.
